(19) United States
(12) Patent Application Publication
(10) Pub. No.: US 2018/0114240 A1
(43) Pub. Date: Apr. 26, 2018

(54) METHOD, SERVER, AND STORAGE MEDIUM FOR PROCESSING ORDER

(71) Applicant: TENCENT TECHNOLOGY (SHENZHEN) COMPANY LIMITED, Shenzhen (CN)

(72) Inventors: Wenpeng ZHANG, Shenzhen (CN); Xinji NIE, Shenzhen (CN); Haixia RAO, Shenzhen (CN); Rui TANG, Shenzhen (CN)

(21) Appl. No.: 15/851,384

(22) Filed: Dec. 21, 2017

Related U.S. Application Data
(63) Continuation of application No. PCT/CN2016/095371, filed on Aug. 15, 2016.

(30) Foreign Application Priority Data
Sep. 7, 2015 (CN) 201510564389.7

(51) Int. Cl. G06Q 30/02

(52) U.S. Cl. CPC G06Q 30/0212; G06Q 20/3274

(57) ABSTRACT

Method, server, and storage medium for processing an order are provided. The method includes: receiving an order processing request carrying order information, and determining a parameter value of at least one preset transaction feature parameter according to the order information; determining, according to a pre-stored corresponding relationship between a parameter value condition and a reduction algorithm, at least one parameter value condition in line with the parameter value from parameter value conditions contained in the corresponding relationship, and determining a reduction algorithm corresponding to the at least one parameter value condition; separately determining, according to each determined reduction algorithm, a reduction value corresponding to each reduction algorithm, and selecting, from determined reduction values, a first reduction value with a maximum value; and performing reduction adjustment on an order amount in the order information according to the first reduction value, and performing an order processing based on the adjusted order information.

### RELATED APPLICATIONS

This application is a continuation application of PCT Patent Application No. PCT/CN2016/095371, filed on Aug. 15, 2016, which claims priority to Chinese Patent Application No. 2015105643897, entitled “METHOD, APPARATUS, AND SYSTEM FOR PROCESSING ORDER” filed on Sep. 7, 2015, all of which is incorporated herein by reference in their entirety.

### FIELD OF THE TECHNOLOGY

The present disclosure generally relates to the field of mobile Internet technologies, and in particular, relates to a method, an apparatus, and a system for processing an order.

### BACKGROUND OF THE DISCLOSURE

With the development of mobile Internet technologies, various payment methods have been used. When selecting a payment method for a purchase, a person may obtain a particular discount. For example, when a person selects to use an application (App) (e.g., WeChat) on an electronic device to make the payment, this person may obtain a fixed-amount discount.

A payment method may be selected according to acquired information to make a payment. Currently, a discount condition and a corresponding discount amount for an activity are usually set as a fixed-amount discount. In one example, ¥ 2 may be deducted when an order amount reaches ¥ 10. Once a person selects a payment method and before making the payment, the person usually knows the fixed-amount discount to be applied and the final amount to be paid.

However, problems arise. With a fixed-amount discount upon selection of a payment method, if the discount amount is not appealing enough to a user, the user may avoid selecting this payment method. In another example, the fixed-amount discount may not be available in certain cases even if that payment method is selected. After knowing this, the user may decide not to select that payment method and the payment method will be less used.

### SUMMARY

One aspect of the present disclosure provides a method for processing an order. The method includes: receiving an order processing request carrying order information, and determining a parameter value of at least one preset transaction feature parameter according to the order information; determining, according to a pre-stored corresponding relationship between a parameter value condition and a reduction algorithm, at least one parameter value condition in line with the parameter value from parameter value conditions contained in the corresponding relationship, and determining a reduction algorithm corresponding to the at least one parameter value condition; separately determining, according to each determined reduction algorithm, a reduction value corresponding to each reduction algorithm, and selecting, from determined reduction values, a first reduction value with a maximum value; and performing reduction adjustment on an order amount in the order information according to the first reduction value, and performing an order processing based on the adjusted order information.

Another aspect of the present disclosure provides a server. The server includes a memory, storing one or more program instructions for a method for processing an order, and one or more processors, coupled to the memory. When executing the one or more program instructions, the one or more processors are configured to receive an order processing request carrying order information, and determine a parameter value of at least one preset transaction feature parameter according to the order information; determine, according to a pre-stored corresponding relationship between a parameter value condition and a reduction algorithm, at least one parameter value condition in line with the parameter value from parameter value conditions contained in the corresponding relationship, and determine a reduction algorithm corresponding to the at least one parameter value condition; separately determine, according to each determined reduction algorithm, a reduction value corresponding to each reduction algorithm, and select, from determined reduction values, a first reduction value with a maximum value; and perform reduction adjustment on an order amount in the order information according to the first reduction value, and perform an order processing based on the adjusted order information.

Another aspect of the present disclosure provides a non-transitory computer-readable storage medium containing computer-executable program instructions for, when executed by a processor, performing a method for processing an order. The method includes: receiving an order processing request carrying order information, and determining a parameter value of at least one preset transaction feature parameter according to the order information; determining, according to a pre-stored corresponding relationship between a parameter value condition and a reduction algorithm, at least one parameter value condition in line with the parameter value from parameter value conditions contained in the corresponding relationship, and determining a reduction algorithm corresponding to the at least one parameter value condition; separately determining, according to each determined reduction algorithm, a reduction value corresponding to each reduction algorithm, and selecting, from determined reduction values, a first reduction value with a maximum value; and performing reduction adjustment on an order amount in the order information according to the first reduction value, and performing an order processing based on the adjusted order information.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without creative efforts.

FIG. 1 is a flowchart of an exemplary method for processing an order according to an embodiment of the present disclosure;

FIG. 2 is a flowchart of another exemplary method for processing an order according to an embodiment of the present disclosure;

FIG. 3 is a schematic diagram of submitting an order according to an embodiment of the present disclosure;

FIG. 4 is a schematic structural diagram of an exemplary apparatus for processing an order according to an embodiment of the present disclosure;

FIG. 5 is a schematic structural diagram of another exemplary apparatus for processing an order according to an embodiment of the present disclosure; and

FIG. 6 is a schematic structural diagram of an exemplary server according to an embodiment of the present disclosure.

### DESCRIPTION OF EMBODIMENTS

To make the objectives, technical solutions, and advantages in the present disclosure clearer, the following further describes the implementation manners of the present disclosure in detail with reference to the accompanying drawings.

An embodiment of the present disclosure provides a system for processing an order. The system includes a terminal and a server. The server may be a server for processing an order, or may be a backend server of a payment application. A processor, a memory, and a transceiver may be disposed in the server. The processor may be used for determining a reduction value corresponding to order information sent by the terminal and processing an order. The memory may be used for storing required data and generated data in the following processing processes. The transceiver may be used for receiving and sending data. A transceiver may be disposed in the terminal. The transceiver may be used for receiving and sending data.

The terminal is configured to send an order processing request carrying order information to the server.

The server is configured to: determine a parameter value of at least one preset transaction feature parameter according to the order information; determine, according to a pre-stored corresponding relationship between a parameter value condition and a reduction algorithm, at least one parameter value condition in line with the parameter value from parameter value conditions included in the corresponding relationship, and determine a reduction algorithm corresponding to the at least one parameter value condition; separately determine, according to each determined reduction algorithm, a reduction value corresponding to each reduction algorithm, and select, from determined reduction values, a first reduction value with a maximum value; and perform reduction adjustment on an order amount in the order information according to the first reduction value, and perform order processing based on the adjusted order information.

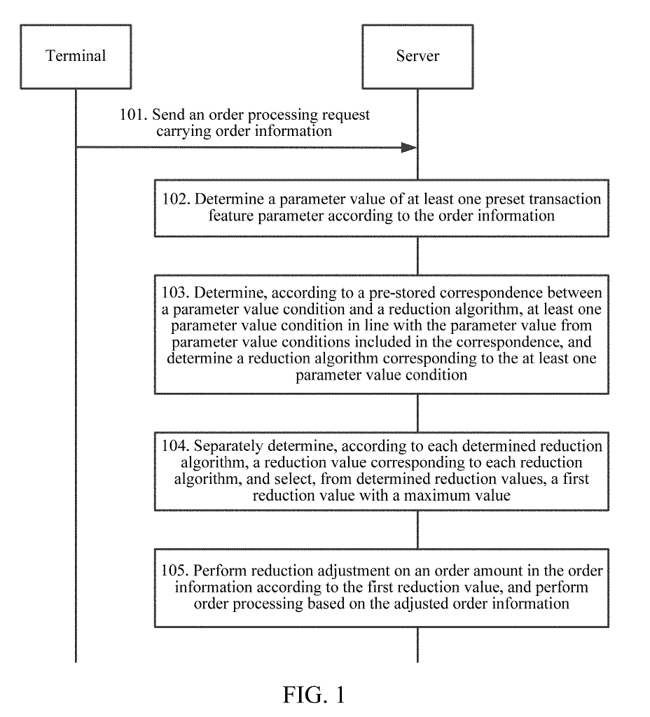

An embodiment of the present disclosure provides a method for processing an order. FIG. 1 is a flowchart of an exemplary method for processing an order according to an embodiment of the present disclosure.

In 101: A terminal sends an order processing request carrying order information to a server.

In 102: The server determines a parameter value of at least one preset transaction feature parameter according to the order information.

In 103: The server determines, according to a pre-stored corresponding relationship between a parameter value condition and a reduction algorithm, at least one parameter value condition in line with the parameter value from parameter value conditions included in the corresponding relationship, and determines a reduction algorithm corresponding to the at least one parameter value condition.

In 104: The server separately determines, according to each determined reduction algorithm, a reduction value corresponding to each reduction algorithm, and selects, from determined reduction values, a first reduction value with a maximum value.

In 105: The server performs reduction adjustment on an order amount in the order information according to the first reduction value, and performs order processing based on the adjusted order information.

As disclosed, an order processing request that is sent by a terminal and carries order information is received, and a parameter value of at least one preset transaction feature parameter is determined according to the order information; at least one parameter value condition in line with the parameter value is determined according to a pre-stored corresponding relationship between a parameter value condition and a reduction algorithm from parameter value conditions included in the corresponding relationship, and a reduction algorithm corresponding to the at least one parameter value condition is determined; a reduction value corresponding to each determined reduction algorithm is separately determined according to each reduction algorithm, and a first reduction value with a maximum value is selected from determined reduction values; and reduction adjustment is performed on an order amount in the order information according to the first reduction value, and order processing is performed based on the adjusted order information. As such, a user, before making a payment, may know that a particular amount is randomly deducted, but may not know the specific amount of the random deduction in a current payment. This may increase user's interest in participating more in the payment process. The user may expect more about the random deduction in next payment and may be encouraged to use the disclosed payment method in next purchase(s). Therefore, the payment method can be used more frequently.

An embodiment of the present disclosure provides a method for processing an order. The method is performed by a server. The server may be a server for processing an order, or may be a backend server of a payment application (for example, WeChat application). A processor, a memory, and a transceiver may be configured in the server. The processor may be used for determining a reduction value corresponding to order information sent by a terminal and processing an order. The memory may be used for storing required data and generated data in the following processing processes. The transceiver may be used for receiving and sending data.

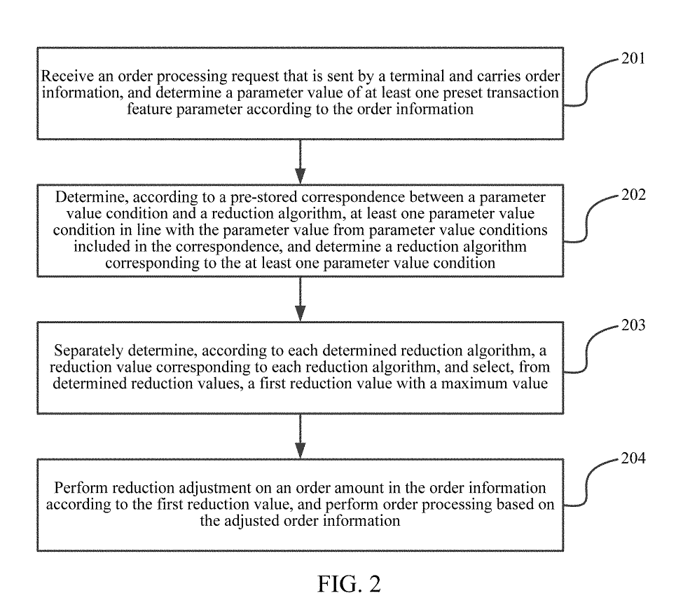

An exemplary processing method on a server side is described in detail below with reference to specific embodiment. FIG. 2 is a flowchart of an exemplary method for processing an order according to various embodiments of the present disclosure.

In 201: Receive an order processing request that is sent by a terminal and carries order information, and determine a parameter value of at least one preset transaction feature parameter according to the order information.

The order may be an electronic voucher for performing online transaction by a payer and a supplier. During online transaction, the payer may order goods such as physical goods, virtual goods, digital goods, or service goods from the supplier by using currency or virtual currency (for example, bonus points or coupons). The transaction feature parameter may be a feature parameter involved in a transaction of the order, for example, a parameter related to a feature of the order. The parameter is, for example, a merchant identifier, an account identifier of a payment user (or a “payment account identifier”), and/or an order amount.

During implementation, when a user (that is, a payment user) who buys an article makes a payment after selecting an article that the user needs to buy in a supermarket or a convenience store, the user may select different payment methods to make a payment. For example, the user may select a cash payment method, a payment method of swiping a bank card or a credit card, or a payment method of application payment such as WeChat payment. The user may obtain different discounts when selecting different payment methods. There may also be no discount activity when a payment method is used. For example, when the cash payment method is used, there may be no discount. When the payment method of application payment is used, a random discount may be obtained. The application payment is used as an example in the following description. Other cases are similar to the application payment, and details are not described again.

When buying an article, the payment user may select the payment method of application payment. A two-dimensional code may be formed on a terminal of the payment user, and the two-dimensional code is to be scanned by a device of a merchant. When the payment user uses the payment method of application payment for the first time, the user may set a bank card or an account balance that is associated with the application payment in an application on the terminal. After the user completes setting, a server may record a fund account (that is, the bank card or the account balance, which may be referred to as a payment fund account) corresponding to an account identifier (which may be a WeChat account) of the payment user. After the payment user selects articles that the payment user needs to buy in a supermarket or a convenience store, the device of the merchant may scan one by one the articles selected by the payment user. In this case, the device of the merchant may have information (which may be a merchant number) of the merchant and an order amount of a current order.

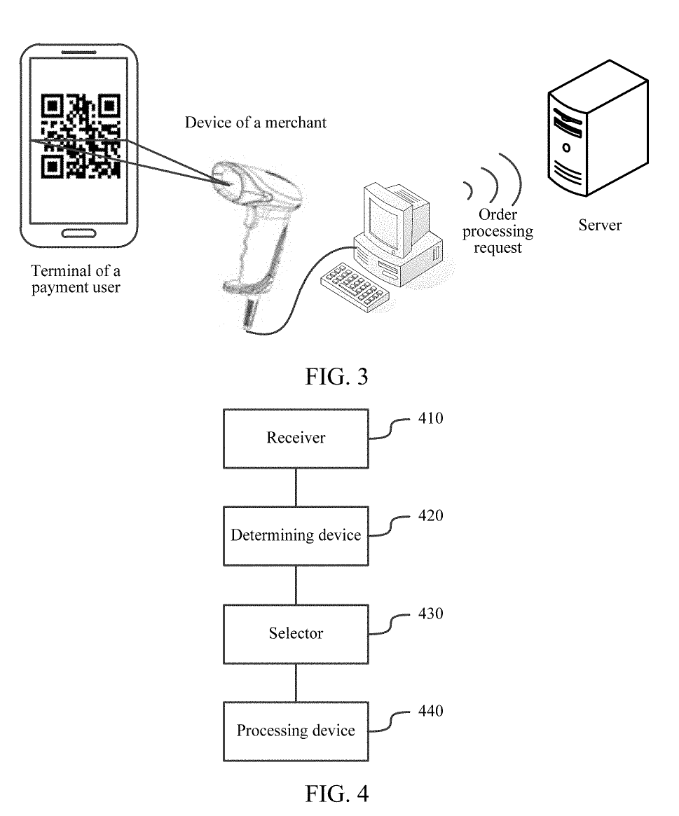

Then, as shown in FIG. 3, the device of the merchant may scan the two-dimensional code. After the scanning succeeds, the device of the merchant obtains the account identifier of the payment user, and uploads the account identifier to a terminal of the merchant. The terminal of the merchant sends an order processing request to the server according to a pre-stored address of the server. The order processing request carries order information. After receiving the order processing request sent by the terminal of the merchant, the server may parse the order processing request to obtain the order information carried in the order processing request. The order information may include a merchant identifier (which may be the merchant number), the order amount, and the account identifier of the payment user.

The server may obtain, from local storage according to the account identifier of the payment user included in the order information, an identifier of the payment fund account corresponding to the account identifier of the payment user, further determines a parameter value of one or more preset transaction feature parameters according to the order information and information that is obtained from a memory of the server according to the order information. For example, at least one preset transaction feature parameter includes the order amount. When the order information includes an order amount of ¥50, a parameter value of the preset transaction feature parameter (the order amount) determined by the server according to the order information is 50.

Optionally, the transaction feature parameter that can be pre-stored by the server may be one or more of the following information: a merchant identifier, an order amount, a quantity of orders submitted by a payment account, a type of a payment fund account, or region information of a merchant.

The merchant identifier may be an identifier used for distinguishing between merchants, and each merchant has a unique merchant identifier such as a merchant number.

During implementation, the server may pre-store the transaction feature parameter and may store a corresponding relationship between a parameter value condition of the transaction feature parameter and a reduction algorithm. There may be one or more transaction feature parameters. The transaction feature parameter may be the merchant identifier, the order amount, the quantity of orders submitted by a payment account, or the type of a payment fund account. The type of a payment fund account may include a type such as an account balance, a UnionPay card, or a credit card. The server may obtain the type of a payment fund account corresponding to the payment account identifier according to the payment account identifier included in the order information and a pre-stored identifier of a payment fund account corresponding to the payment account identifier. The type of a payment fund account may further be region information of a merchant. The transaction feature parameter may be any combination of the foregoing information, that is, a parameter value of the combination forms a parameter value condition corresponding to the reduction algorithm.

Optionally, after receiving the order processing request, the server may first determine whether the current payment user can participate in a current discount activity. Correspondingly, a processing process of in 201 may be as follows: receiving the order processing request that is sent by the terminal and carries order information, and obtaining a total quantity of reductions of pre-stored reduction algorithms within a time period from a preset historical moment to a current moment; and when the total quantity of reductions is less than a preset quantity upper limit, determining a parameter value of at least one preset transaction feature parameter according to the order information.

During implementation, a technician may preset a discount quantity corresponding to a current discount activity, that is, the technician may preset a total quantity (that is, the preset quantity upper limit) that all the reduction algorithms stored on the server can be used. Each time after selecting a reduction value corresponding to the reduction algorithms, the server may count a total quantity of reductions of using the reduction algorithms within a preset historical time period (that is, the time period from the preset historical moment to the current moment, and the preset historical moment may be a start moment of the discount activity).

After receiving the order processing request sent by the terminal, the server may obtain a total quantity of reductions of the reduction algorithms within the time period from the preset historical moment to the current moment, and further determine a value relationship between the obtained total quantity of reductions and the preset quantity upper limit. When the total quantity of reductions is less than the preset quantity upper limit, the server may determine a parameter value of at least one preset transaction feature parameter according to the method of in 201. When the total quantity of reductions is equal to the preset quantity upper limit, the server may not perform subsequent processing.

Optionally, after receiving the order processing request, the server may first determine whether the current payment user can participate in a current discount activity. Correspondingly, a processing process of in 201 may be as follows: receiving the order processing request that is sent by the terminal and carries the order information, and obtaining a total quantity of reductions of a payment account identifier included in the order information sent by the terminal within a time period from a preset historical moment to a current moment; and when the total quantity of reductions is less than a preset quantity upper limit, determining a parameter value of at least one preset transaction feature parameter according to the order information.

During implementation, a technician may preset a discount quantity, that is, the preset quantity upper limit, for each payment user in a current discount activity. Each timer after selecting a reduction value corresponding to a reduction algorithm according to the order information carried in the order processing request, the server may count the total quantity of reductions of the payment account identifier included in the order information within a preset historical time period (that is, the time period from the preset historical moment to the current moment, and the preset historical moment may be a start moment of the discount activity).

After receiving the order processing request sent by the terminal, the server may obtain a total quantity of reductions of the payment account identifier in the order information within the preset historical time period, and further determine a value relationship between the obtained total quantity of reductions and the preset quantity upper limit. When the total quantity of reductions is less than the preset quantity upper limit, the server may determine, according to the method of in 201, a parameter value of at least one preset transaction feature parameter according to the order information. When the total quantity of reductions is equal to the preset quantity upper limit, the server may not perform subsequent processing.

In 202: Determine, according to a pre-stored corresponding relationship between a parameter value condition and a reduction algorithm, at least one parameter value condition in line with the parameter value from parameter value conditions included in the corresponding relationship, and determine a reduction algorithm corresponding to the at least one parameter value condition.

The reduction algorithm may be an algorithm used for obtaining a reduction value, that is, a rule of a discount that a payment user can obtain, or may be a random-reduction-value algorithm, a fixed-reduction-value algorithm, or a fixed-reduction-target-value algorithm. How to obtain a corresponding reduction value according to an algorithm is described below in detail.

During implementation, a technician may preset a corresponding relationship between a parameter value condition and a reduction algorithm according to an activity requirement. As shown in Table 1, the corresponding relationship may not be one-to-one corresponding relationship. That is, one same parameter value condition may correspond to multiple reduction algorithms. For example, the parameter value condition is that an order amount is greater than ¥100. The parameter value condition may correspond to a reduction algorithm A or may correspond to a reduction algorithm B. Parameter value conditions corresponding to the reduction algorithms may not be mutually exclusive. That is, a parameter value of one or more preset transaction feature parameters determined by same order information may meet multiple parameter value conditions at the same time. For example, a parameter value condition 1 is that an order amount is greater than ¥10, and a corresponding reduction algorithm is the reduction algorithm A.

A parameter value condition 2 is that an order amount is greater than ¥50, and a corresponding reduction algorithm is the reduction algorithm B. It can be known that the parameter value condition 2 includes the parameter value condition 1 (that is, when the parameter value condition 2 is met, the parameter value condition 1 is definitely met). When an order amount in order information is ¥70, a parameter value, determined by the order information, of one or more preset transaction feature parameters meets the parameter value condition 1 and the parameter value condition 2 at the same time. After the parameter value of one or more preset transaction feature parameter is determined, the server may determine, according to Table 1, which parameter value conditions included in the corresponding relationship are in line with the parameter value, and may obtain a parameter value condition in line with the determined parameter value. One or more parameter value conditions may be met. According to the corresponding relationship, pre-stored by the technician on the server, between a parameter value condition and a reduction algorithm, a reduction algorithm corresponding to the at least one parameter value condition in line with the parameter values is determined. There may be one or more corresponding reduction algorithms.

TABLE 1

| Parameter value condition | Reduction algorithm |
|---|---|
| Parameter value condition 1 | Reduction algorithm A |
| Parameter value condition 2 | Reduction algorithm B |
| Parameter value condition 3 | Reduction algorithm C |
| Parameter value condition 1 | Reduction algorithm D |
| . . . . . . | . . . . . . |

Optionally, when a reduction algorithm corresponding to one or more parameter conditions is determined, a sum of reduction values deducted by the reduction algorithms in the past may be considered. Correspondingly, a processing process may be as follows: separately obtaining a sum of reduction values of the reduction algorithm corresponding to the at least one parameter value condition within a time period from a preset historical moment to a current moment; and determining, from the reduction algorithm corresponding to the at least one parameter value condition, a reduction algorithm having a sum of reduction values less than a preset upper limit of a reduction value.

During implementation, a technician may preset upper limits of reduction values corresponding to all the reduction algorithms stored on the server. Each time after selecting a reduction value corresponding to a reduction algorithm, the server may count a sum of reduction values of the reduction algorithm within a preset historical time period (that is, the time period from the preset historical moment to the current moment, and the preset historical moment is a start moment of a discount activity). Reduction values determined each time within the preset historical time period may be accumulated to obtain a sum of the reduction values.

After determining the at least one parameter value condition in line with the parameter values, the server may obtain a sum of reduction values of the reduction algorithm corresponding to each determined parameter value condition within the time period from the preset historical moment to the current moment, and further select a reduction algorithm having a sum of reduction values less than the corresponding preset upper limit (which may be slightly less than a budgetary fund corresponding to the reduction algorithm) of a reduction value. When the sum of the reduction values is greater than the preset upper limit of a reduction value, the reduction algorithm takes effect in the order processing (that is, the server no longer calculates a reduction value corresponding to the reduction algorithm), and the reduction algorithm is no longer takes effect in subsequent processing either. Therefore, a sufficient budgetary fund may be ensured to enable a payment user to obtain a discount, avoiding that the budgetary fund is used up during a discount activity and cannot pay a reduction value to a merchant.

For example, a parameter value determined according to the order information meets the parameter value condition 1 corresponding to the reduction algorithm A, and the upper limit of a reduction value corresponding to the reduction algorithm A is ¥100,000. After the discount activity is started, when a discount amount (that is, the sum of reduction values) offered to payment users by applying the reduction algorithm A is ¥80,000 (8<10), an eventually determined reduction algorithm corresponding to the order information includes the reduction algorithm A. When the discount amount (that is, the sum of reduction values) offered to payment users by applying the reduction algorithm A is ¥101,000 (10. 1>10), the eventually determined reduction algorithm corresponding to the order information does not include the reduction algorithm A.

Optionally, when a reduction algorithm corresponding to one or more parameter conditions is determined, a quantity of reductions of the reduction algorithms in the past may be considered. Correspondingly, a processing process may be as follows: separately obtaining a quantity of reductions of the reduction algorithm corresponding to the at least one parameter value condition within a time period from a preset historical moment to a current moment; and determining, from the reduction algorithm corresponding to the at least one parameter value condition, a reduction algorithm having a quantity of reductions less than a preset quantity upper limit.

During implementation, a technician may preset a quantity of reductions corresponding to all the reduction algorithms stored on the server. Each time after selecting a reduction value corresponding to a reduction algorithm, the server may count a quantity of reductions of the reduction algorithm within a preset historical time period (that is, the time period from the preset historical moment to the current moment, and the preset historical moment may be a start moment of the discount activity).

After determining the at least one parameter value condition in line with a parameter value, the server may obtain a quantity of reductions of the reduction algorithm corresponding to each determined parameter value conditions within the time period from the preset historical moment to the current moment, and further select a reduction algorithm having a quantity of reductions less than a corresponding preset quantity upper limit of reductions. That is, when the quantity of reductions within the time period from the preset historical moment to the current moment reaches the preset quantity upper limit of reductions, the reduction algorithm does not take effect in the order processing (that is, the server no longer calculates a reduction value corresponding to the reduction algorithm), and the reduction algorithm no longer takes effect in subsequent processing. For example, a parameter value determined according to the order information meets the parameter value condition 1 corresponding to the reduction algorithm A, and the preset quantity upper limit corresponding to the reduction algorithm A is 100.

After the discount activity is started, when the quantity of discounts offered to payment users by applying the reduction algorithm A is 80 (80<100), an eventually determined reduction algorithm corresponding to the order information includes the reduction algorithm A. When the quantity of discounts offered to payment users by applying the reduction algorithm A reaches 100, the eventually determined reduction algorithm corresponding to the order information does not include the reduction algorithm A. Therefore, the reduction algorithms pre-stored on the server are all used, and it is avoided that a reduction algorithm keeps being used while the rest reduction algorithms are not used. For example, reduction algorithms determined according to the determined parameter value conditions include the reduction algorithm B and a reduction algorithm C.

A reduction value determined by using the reduction algorithm C is relatively large, and a reduction value determined by using the reduction algorithm B is relatively small. Therefore, when an eventual reduction algorithm is selected according to a principle of selecting a maximum reduction value, the quantity of times that the reduction algorithm C is selected is far greater than the quantity of times that the reduction algorithm B is selected. As a result, when the reduction algorithm B and the reduction algorithm C are determined at the same time, the reduction algorithm B is always not used as an eventual reduction algorithm. When the quantity of times of using the reduction algorithm C is limited, when the quantity of times of using the reduction algorithm C reaches a preset quantity upper limit, the reduction algorithm B may be selected as an eventual reduction algorithm.

Optionally, when a reduction algorithm corresponding to one or more parameter conditions is determined, a quantity of reductions of the reduction algorithm for each payment user in the past may be considered. Correspondingly, a processing process may be as follows: separately obtaining a quantity of reductions of an account identifier of a payment user included in order information of the reduction algorithm corresponding to the at least one parameter value condition within a time period from a preset historical moment to a current moment; and determining, from the reduction algorithm corresponding to the at least one parameter value condition, a reduction value algorithm having a quantity of reductions less than a preset quantity upper limit.

During implementation, a technician may preset a quantity of reductions that are offered to each payment user and correspond to all the reduction algorithms stored on the server. Each time after determining a reduction value corresponding to a reduction algorithm, the server may count a quantity of reductions corresponding to an account identifier of the payment user within a preset historical time period (that is, the time period from the preset historical moment to the current moment, and the preset historical moment may be a start moment of the discount activity).

After determining the at least one parameter value condition in line with a parameter value, the server may obtain a quantity of reductions of the payment account identifier carried in the corresponding order information of the reduction algorithms corresponding to each determined parameter value condition within the time period from the preset historical moment to the current moment, and select a reduction value algorithm having a quantity of reductions less than the corresponding preset quantity upper limit of reductions. That is, when the quantity of reductions of the payment account identifier within the time period from the preset historical moment to the current moment reaches the preset quantity upper limit of reductions, the reduction algorithm does not take effect in current order processing (that is, the server no longer calculates a reduction value corresponding to the reduction algorithm), and the reduction algorithm no longer takes effect in subsequent processing.

For example, it may be preset that each payment user (a payment account identifier corresponding to the payment user may be denoted as Q) may use the reduction algorithm A three times. When the quantity of times of using the reduction algorithm A by Q in the past reaches 3, even when a parameter value meets a parameter value condition of the reduction algorithm A, a reduction algorithm selected according to the parameter value condition does not include the reduction algorithm A.

In 203: Separately determine, according to each determined reduction algorithm, a reduction value corresponding to each reduction algorithm, and select, from determined reduction values, a first reduction value with a maximum value.

During implementation, after at least one reduction algorithm is determined, a reduction value corresponding to each reduction algorithm may be respectively determined. After all the reduction values are obtained, a reduction value with a maximum value is selected as the first reduction value.

Optionally, the determined reduction algorithms may include a first random-reduction-value algorithm. A processing process of obtaining a corresponding reduction value by applying the first random-reduction-value algorithm may be as follows: obtaining a preset first reduction value range corresponding to the first random-reduction-value algorithm, and randomly selecting a reduction value from the first reduction value range as a reduction value corresponding to the first random-reduction-value algorithm.

The random-reduction-value algorithm may be an algorithm corresponding to the reduction value range. That is, each reduction value range may be considered as a random-reduction-value algorithm. The reduction value range may be a range of an amount that can be deducted from an order amount, and is a discount rule that a payment user can participate in. For example, the reduction value ranges may be [1, 3] and [0, 10], and different reduction value ranges [1, 3] and [0,10] may be considered as two random-reduction-value algorithms. The first random-reduction-value algorithm may be one of all the random-reduction-value algorithms pre-stored on a server, that is, correspond to one of all the reduction value ranges. For example, a reduction value range corresponding to the first random-reduction-value algorithm may be [1, 3] or [0, 10].

During implementation, the determined reduction algorithms may include at least one random-reduction-value algorithm, that is, include at least the first random-reduction-value algorithm. When the determined reduction algorithms include the first random-reduction-value algorithm, the server may obtain a reduction value range corresponding to the first random-reduction-value algorithm, and may further randomly select a reduction value (that is, an amount that can be deducted from an order amount) from the obtained reduction value range as a reduction value corresponding to the first random-reduction-value algorithm. Specifically, a technician may preset weights of reduction values in the reduction value range.

After the first reduction value range is determined, the server may obtain weights of the reduction values in the first reduction value range, obtain probabilities of the reduction values according to the weights, and select a reduction value with a maximum probability as a reduction value corresponding to the order information. Alternatively, the server may randomly select a reduction value from the determined first reduction value range and further use the selected reduction value as the reduction value corresponding to the first random-reduction-value algorithm. For example, pre-stored reduction value ranges include [1, 3], [0, 10], [5, 10], and [0,5]. The first reduction value range corresponding to the first random-reduction-value algorithm determined according to a parameter value condition is [5, 10]. A numerical value 7 is randomly selected from the range of ¥5 to ¥10. The selected reduction value ¥7 (that is, the reduction value corresponding to the first random-reduction-value algorithm) may be deducted from the order amount.

Optionally, the parameter value condition corresponding to the first random-reduction-value algorithm may be that the order amount is greater than a preset amount. The preset amount may be greater than an endpoint value of the first reduction value range corresponding to the first random-reduction-value algorithm, or may be only greater than a minimum endpoint value (which may be referred to as the minimum endpoint value) in the endpoints. For a case in which the preset amount is only greater than the minimum endpoint value, that is, when the order amount is between two endpoint values and a reduction value is randomly selected in the first reduction value range, a reduction value may be randomly selected between the minimum endpoint value and the order amount. In this way, it may be ensured that the selected reduction value is not greater than the order amount.

For example, the reduction value ranges include [10, 15] and [5, 10], and the corresponding parameter value condition is that the order amount is greater than the minimum endpoint value in the reduction value range. When the order amount is ¥7, the determined reduction value range is [5, 10]. When a reduction value is randomly selected from [5, 10], the randomly selected reduction value may be ¥8, and the reduction amount is greater than the order amount. In this case, the determined reduction value range [5, 10] may be adjusted according to the order amount. That is, a reduction value is randomly selected from [5, 7]. Therefore, the selected reduction value is not greater than the order amount.

Optionally, the determined reduction algorithms may include a first fixed-reduction-value algorithm, and a processing process of obtaining a corresponding reduction value by applying the first fixed-reduction-value algorithm is as follows: obtaining a preset reduction value corresponding to the first fixed-reduction-value algorithm.

The fixed-reduction-value algorithm may be an algorithm corresponding to a reduction value. That is, each reduction value pre-stored on the server may be considered as a fixed-reduction-value algorithm. The reduction value is a fixed amount that can be deducted from the order amount, and is a discount rule (which may be referred to as a fixed amount deduction rule) that a payment user can participate in. That is, when a reduction value is determined, the fixed value may be deducted from the order amount. For example, the reduction value may be ¥8. 8 or ¥9. 9. Different reduction values ¥8. 8 and ¥9. 9 may be considered as two different fixed-reduction-value algorithms (that is, when different reduction values are selected, different amounts may be deducted from the order amount). The first fixed-reduction-value algorithm may be one of all the fixed-reduction-value algorithms pre-stored on a server, that is, correspond to one of all the reduction values. For example, a reduction value corresponding to the first fixed-reduction-value algorithm may be ¥8. 8 or ¥9. 9.

During implementation, the determined reduction algorithms may include at least one fixed-reduction-value algorithm, that is, include at least the first fixed-reduction-value algorithm. When the determined reduction algorithms include the first fixed-reduction-value algorithm, the server may obtain a reduction value corresponding to the first fixed-reduction-value algorithm, that is, an amount that can be deducted from the order amount. The obtained corresponding reduction value is the reduction value corresponding to the first fixed-reduction-value algorithm. For example, pre-stored reduction values include ¥8. 8 and ¥9. 9. When the reduction value corresponding to the first fixed-reduction-value algorithm determined according to a parameter value condition is ¥8. 8, ¥8. 8 may be deducted from the order amount.

Optionally, the determined reduction algorithms may include a first fixed-reduction-target-value algorithm. A processing process of obtaining a corresponding reduction value by applying the first fixed-reduction-target-value algorithm may be as follows: obtaining a preset first reduction target value corresponding to the first fixed-reduction-target-value algorithm, calculating a difference between the order amount in the order information sent by the terminal and the first reduction target value, and determining the difference as a reduction value corresponding to the first fixed-reduction-target-value algorithm.

The fixed-reduction-target-value algorithm may be an algorithm corresponding to a reduction target value. That is, each reduction target value pre-stored on the server may be considered as a fixed-reduction-target-value algorithm. The reduction target value is a fixed amount to which the order amount can be reduced, and is a discount rule (which may be referred to as a “reduce-to” rule) that a payment user can participate in. That is, when a reduction target value is determined, the order amount may be reduced to the fixed value. For example, the reduction target value may be ¥19. 9 or ¥29. 9. Different reduction target values ¥19. 9 and ¥29. 9 may be considered as two different fixed-reduction-target-value algorithms (that is, when different reduction target values are selected, the order amount may be reduced to different amounts). The fixed-reduction-target-value algorithm may be one of all the fixed-reduction-target-value algorithms pre-stored on the server, that is, correspond to one of all the reduction target values. For example, a reduction target value corresponding to the first fixed-reduction-target-value algorithm may be ¥19. 9 or ¥29. 9.

During implementation, the determined reduction algorithms may include at least one fixed-reduction-target-value algorithm, that is, include at least the first fixed-reduction-target-value algorithm. When the determined reduction algorithms include the first fixed-reduction-target-value algorithm, the server may obtain a reduction target value corresponding to the fixed-reduction-target-value algorithm, that is, the first reduction target value. After the first reduction target value is obtained, a corresponding difference is obtained by subtracting the first reduction target value from an order amount in order information sent by a terminal, and the obtained difference may be used as a reduction value corresponding to the first fixed-reduction-target-value algorithm. For example, pre-stored reduction target values include ¥19. 9 and ¥29. 9. A reduction target value corresponding to the first fixed-reduction-target-value algorithm determined according to a parameter value condition is ¥19. 9. The order amount may be reduced to ¥19. 9. A corresponding reduction value may be obtained when 19. 9 is subtracted from the order amount.

In 204: Perform reduction adjustment on an order amount in the order information according to the first reduction value, and perform order processing based on the adjusted order information.

During implementation, after the first reduction value, that is, a discount amount, is determined, a reduction value may be deducted from the order amount in the order information to obtain an amount that needs to be actually paid by a payment user. An order is processed based on the obtained amount that needs to be actually paid. Specifically, the amount that needs to be actually paid may be deducted from a fund amount corresponding to a payment account. In addition, the server may obtain a merchant fund account corresponding to a merchant number according to the merchant number in the order information, and the server may transfer, to the merchant fund account, an order amount before adjustment.

Optionally, after the order is processed, a payment success notification may be sent to the terminal on which the payment account is logged in. Correspondingly, a processing process may be as follows: sending a payment success notification to a terminal on which a payment account in the order information sent by the terminal is logged in, where the payment success notification carries the first reduction value and the adjusted order amount.

During implementation, after processing the order, the server may send a payment success notification to a terminal on which a payment account corresponding to a payment account identifier in the order information sent to the terminal is logged in. The payment success notification may carry the randomly selected first reduction value and an amount (that is, the adjusted order amount) that needs to be actually paid by the payment user. The terminal may receive the payment success notification sent by the server, parse the payment success notification to obtain the reduction value and the adjusted order amount that are carried in the payment success notification, and provide a pop-up prompt interface. The reduction value and the adjusted order amount may be displayed in the prompt interface. That is, the payment user may acquire the reduction value corresponding to a current order after making a payment by using a payment method of application payment.

As disclosed, an order processing request that is sent by a terminal and carries order information is received, and a parameter value of at least one preset transaction feature parameter is determined according to the order information; at least one parameter value condition in line with the parameter value is determined according to a pre-stored corresponding relationship between a parameter value condition and a reduction algorithm from parameter value conditions included in the corresponding relationship, and a reduction algorithm corresponding to the at least one parameter value condition is determined; a reduction value corresponding to each determined reduction algorithm is separately determined according to each reduction algorithm, and a first reduction value with a maximum value is selected from determined reduction values; and reduction adjustment is performed on an order amount in the order information according to the first reduction value, and order processing is performed based on the adjusted order information. As such, a user, before making a payment, may know that a particular amount is randomly deducted, but may not know the specific amount of the random deduction in a current payment. This may increase user's interest in participating more in the payment process. The user may expect more about the random deduction in next payment and may be encouraged to use the disclosed payment method in next purchase(s). Therefore, the payment method can be used more frequently.

Various embodiments of the present disclosure further provide an apparatus for processing an order. As shown in FIG. 4, an exemplary apparatus includes:

a receiver 410, configured to: receive an order processing request that is sent by a terminal and carries order information, and determine a parameter value of at least one preset transaction feature parameter according to the order information;

a determining device 420, configured to: determine, according to a pre-stored corresponding relationship between a parameter value condition and a reduction algorithm, at least one parameter value condition in line with the parameter value from parameter value conditions included in the corresponding relationship, and determine a reduction algorithm corresponding to the at least one parameter value condition;

a selector 430, configured to: separately determine, according to each determined reduction algorithm, a reduction value corresponding to each reduction algorithm, and select, from determined reduction values, a first reduction value with a maximum value; and

a processing device 440, configured to: perform reduction adjustment on an order amount in the order information according to the first reduction value, and perform order processing based on the adjusted order information.

Optionally, the receiver 410 is configured to:

receive the order processing request that is sent by the terminal and carries the order information;

obtain a total quantity of reductions of pre-stored reduction algorithms within a time period from a preset historical moment to a current moment; and

determine, when the total quantity of reductions is less than a preset quantity upper limit, the parameter value of the at least one preset transaction feature parameter according to the order information.

Optionally, the receiver 410 is configured to:

receive the order processing request that is sent by the terminal and carries the order information;

obtain a total quantity of reductions of a payment account identifier included in the order information sent by the terminal within a time period from a preset historical moment to a current moment; and

determine, when the total quantity of reductions is less than a preset quantity upper limit, the parameter value of the at least one preset transaction feature parameter according to the order information.

Optionally, the determining device 420 is configured to:

separately obtain a sum of reduction values of the reduction algorithm corresponding to the at least one parameter value condition within a time period from a preset historical moment to a current moment; and

determine, from the reduction algorithm corresponding to the at least one parameter value condition, a reduction algorithm having a sum of reduction values less than a preset upper limit of a reduction value.

Optionally, the determining device 420 is configured to:

separately obtain a quantity of reductions of the reduction algorithm corresponding to the at least one parameter value condition within a time period from a preset historical moment to a current moment; and

determine, from the reduction algorithm corresponding to the at least one parameter value condition, a reduction algorithm having a quantity of reductions less than a preset quantity upper limit.

Optionally, the determined reduction algorithms include at least a first random-reduction-value algorithm; and

the selector 430 is configured to:

obtain a preset first reduction value range corresponding to the first random-reduction-value algorithm, and randomly select a reduction value in the first reduction value range as a reduction value corresponding to the first random-reduction-value algorithm.

Optionally, the determined reduction algorithms include at least a first fixed-reduction-value algorithm; and

the selector 430 is configured to:

obtain a preset reduction value corresponding to the first fixed-reduction-value algorithm.

Optionally, the determined reduction algorithms include at least a first fixed-reduction-target-value algorithm; and

the selector 430 is configured to:

obtain a preset first reduction target value corresponding to the first fixed-reduction-target-value algorithm, calculate a difference between the order amount in the order information sent by the terminal and the first reduction target value, and determine the difference as a reduction value corresponding to the first fixed-reduction-target-value algorithm.

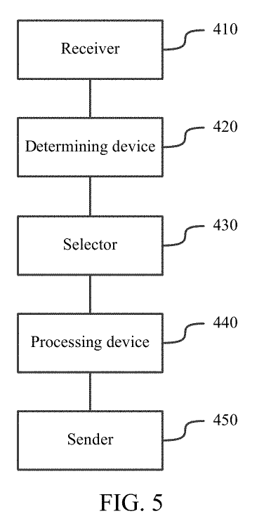

Optionally, as shown in FIG. 5, the apparatus further includes a sender 450, configured to:

perform reduction adjustment on the order amount in the order information according to the first reduction value, and send, after performing order processing based on the adjusted order information, a payment success notification to a terminal on which a payment account in the order information sent by the terminal is logged in, where the payment success notification carries the first reduction value and the adjusted order amount.

Optionally, the at least one preset transaction feature parameter includes one or more of the following information: a merchant identifier, an order amount, a quantity of orders submitted by a payment account, a type of a payment fund account, or region information of a merchant.

As disclosed, an order processing request that is sent by a terminal and carries order information is received, and a parameter value of at least one preset transaction feature parameter is determined according to the order information; at least one parameter value condition in line with the parameter value is determined according to a pre-stored corresponding relationship between a parameter value condition and a reduction algorithm from parameter value conditions included in the corresponding relationship, and a reduction algorithm corresponding to the at least one parameter value condition is determined; a reduction value corresponding to each determined reduction algorithm is separately determined according to each reduction algorithm, and a first reduction value with a maximum value is selected from determined reduction values; and reduction adjustment is performed on an order amount in the order information according to the first reduction value, and order processing is performed based on the adjusted order information. As such, a user, before making a payment, may know that a particular amount is randomly deducted, but may not know the specific amount of the random deduction in a current payment. This may increase user's interest in participating more in the payment process. The user may expect more about the random deduction in next payment and may be encouraged to use the disclosed payment method in next purchase(s). Therefore, the payment method can be used more frequently.

It should be noted that the above functional modules are only described for exemplary purposes when the apparatus for processing an order provided by the foregoing embodiments processes an order. In actual applications, the functions may be allocated to different functional modules according to specific needs, which means that the internal structure of the apparatus is divided to different functional modules to complete all or some of the above described functions. In addition, the apparatus for processing an order provided by the foregoing embodiments are based on the same concept as the method for processing an order in the foregoing embodiments. For the specific implementation process, refer to the method embodiments, and the details are not described herein again.

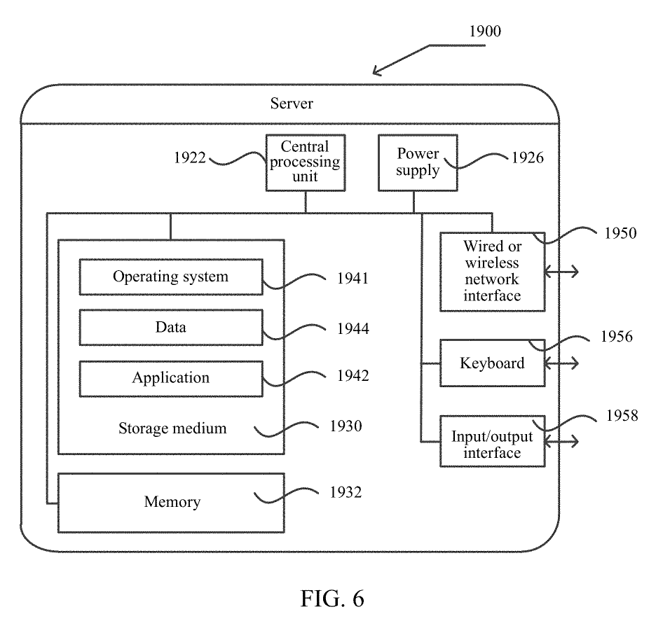

FIG. 6 is a schematic structural diagram of a server according to an embodiment of the present disclosure. A server 1900 may vary greatly due to different configurations or performance, and may include one or more central processing units (CPUs) 1922 (for example, one or more processors), a memory 1932, and one or more storage media 1930 (for example, one or more mass storage devices) that store applications 1942 or data 1944. The memory 1932 and the storage medium 1930 may have temporary storage or persistent storage. A program stored in the storage medium 1930 may include one or more modules (not shown in the figure), and each module may include a series of instructions and operations for a statistics server. Further, the CPU 1922 may be set to communicate with the storage medium 1930, and perform, on the statistics server 1900, the series of instructions and operations in the storage medium 1930.

The server 1900 may further include one or more power supplies 1926, one or more wired or wireless network interfaces 1950, one or more input/output interfaces 1958, one or more keyboards 1956, and/or one or more operating systems 1941, for example, Windows Server™, Mac OS X™, Unix™, Linux™, or FreeBSD™.

The server 1900 may include a memory and one or more programs. The one or more programs are stored in the memory and configured to be executed by the one or more processors to perform the method for processing an order in the foregoing embodiments.

In an exemplary embodiment, a non-transitory computer readable storage medium including instructions, for example, a memory including instructions, is further provided. The instructions may be executed by a processor of a mobile terminal to implement the method for processing an order. For example, the non-transitory computer readable storage medium may be a read-only memory (ROM), a random access memory (RAM), a compact disc read-only memory (CD-ROM), a magnetic tape, a floppy disk, an optical data storage device, and the like.

In an exemplary embodiment, an apparatus for processing an order is provided. The apparatus may include a receiver configured to receive an order processing request that is sent by a terminal and carries order information, and determine a parameter value of at least one preset transaction feature parameter according to the order information. The apparatus may also include a determining device configured to: determine, according to a pre-stored corresponding relationship between a parameter value condition and a reduction algorithm, at least one parameter value condition in line with the parameter value from parameter value conditions included in the corresponding relationship, and determine a reduction algorithm corresponding to the at least one parameter value condition. The apparatus may further include a selector configured to separately determine, according to each determined reduction algorithm, a reduction value corresponding to each reduction algorithm, and select, from determined reduction values, a first reduction value with a maximum value. The apparatus may further include a processing device configured to: perform reduction adjustment on an order amount in the order information according to the first reduction value, and perform order processing based on the adjusted order information.

Various embodiments may further include a method for processing an order. The method may include sending, by a terminal, an order processing request carrying order information to a server; determining, by the server, a parameter value of at least one preset transaction feature parameter according to the order information; determining, by the server according to a pre-stored corresponding relationship between a parameter value condition and a reduction algorithm, at least one parameter value condition in line with the parameter value from parameter value conditions included in the corresponding relationship, and determining a reduction algorithm corresponding to the at least one parameter value condition; separately determining, by the server according to each determined reduction algorithm, a reduction value corresponding to each reduction algorithm, and selecting, from determined reduction values, a first reduction value with a maximum value; and performing, by the server, reduction adjustment on an order amount in the order information according to the first reduction value, and performing order processing based on the adjusted order information.

Various embodiments may further include a system for processing an order. The system includes a terminal and a server. The terminal is configured to send an order processing request carrying order information to the server. The server is configured to: determine a parameter value of at least one preset transaction feature parameter according to the order information; determine, according to a pre-stored corresponding relationship between a parameter value condition and a reduction algorithm, at least one parameter value condition in line with the parameter value from parameter value conditions included in the corresponding relationship, and determine a reduction algorithm corresponding to the at least one parameter value condition; separately determine, according to each determined reduction algorithm, a reduction value corresponding to each reduction algorithm, and select, from determined reduction values, a first reduction value with a maximum value; and perform reduction adjustment on an order amount in the order information according to the first reduction value, and perform order processing based on the adjusted order information.

The technical solutions provided in the embodiments of the present disclosure have the following beneficial effects.

As disclosed, an order processing request that is sent by a terminal and carries order information is received, and a parameter value of at least one preset transaction feature parameter is determined according to the order information; at least one parameter value condition in line with the parameter value is determined according to a pre-stored corresponding relationship between a parameter value condition and a reduction algorithm from parameter value conditions included in the corresponding relationship, and a reduction algorithm corresponding to the at least one parameter value condition is determined; a reduction value corresponding to each determined reduction algorithm is separately determined according to each reduction algorithm, and a first reduction value with a maximum value is selected from determined reduction values; and reduction adjustment is performed on an order amount in the order information according to the first reduction value, and order processing is performed based on the adjusted order information.

As such, a user, before making a payment, may know that a particular amount is randomly deducted, but may not know the specific amount of the random deduction in a current payment. This may increase user's interest in participating more in the payment process. The user may expect more about the random deduction in next payment and may be encouraged to use the disclosed payment method in next purchase(s). Therefore, the payment method can be used more frequently.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for processing an order, comprising:
receiving an order processing request carrying order information, and determining a parameter value of at least one preset transaction feature parameter according to the order information;
determining, according to a pre-stored corresponding relationship between a parameter value condition and a reduction algorithm, at least one parameter value condition in line with the parameter value from parameter value conditions contained in the corresponding relationship, and determining a reduction algorithm corresponding to the at least one parameter value condition;
separately determining, according to each determined reduction algorithm, a reduction value corresponding to each reduction algorithm, and selecting, from determined reduction values, a first reduction value with a maximum value; and
performing reduction adjustment on an order amount in the order information according to the first reduction value, and performing an order processing based on the adjusted order information.

2. The method according to claim 1, wherein the receiving an order processing request carrying order information, and determining a parameter value of at least one preset transaction feature parameter according to the order information comprise:
receiving the order processing request that is sent by a terminal and carries the order information;
obtaining a total quantity of reductions of pre-stored reduction algorithms within a time period from a preset historical moment to a current moment; and
determining, when the total quantity of reductions is less than a preset quantity upper limit, the parameter value of the at least one preset transaction feature parameter according to the order information.

3. The method according to claim 1, wherein the receiving an order processing request carrying order information, and determining a parameter value of at least one preset transaction feature parameter according to the order information comprise:
receiving the order processing request that is sent by a terminal and carries the order information;
obtaining a total quantity of reductions of a payment account identifier contained in the order information sent by the terminal within a time period from a preset historical moment to a current moment; and
determining, when the total quantity of reductions is less than a preset quantity upper limit, the parameter value of the at least one preset transaction feature parameter according to the order information.

4. The method according to claim 1, wherein the determining a reduction algorithm corresponding to the at least one parameter value condition comprises:
separately obtaining a sum of reduction values of the reduction algorithm corresponding to the at least one parameter value condition within a time period from a preset historical moment to a current moment; and
determining, from the reduction algorithm corresponding to the at least one parameter value condition, a reduction algorithm having a sum of reduction values less than a preset upper limit of a reduction value.

5. The method according to claim 1, wherein the determining a reduction algorithm corresponding to the at least one parameter value condition comprises:
separately obtaining a quantity of reductions of the reduction algorithm corresponding to the at least one parameter value condition within a time period from a preset historical moment to a current moment; and
determining, from the reduction algorithm corresponding to the at least one parameter value condition, a reduction algorithm having a quantity of reductions less than a preset quantity upper limit.

6. The method according to claim 1, wherein the determined reduction algorithms comprise at least a first random-reduction-value algorithm; and
a reduction value corresponding to the first random-reduction-value algorithm is determined by:
obtaining a preset first reduction value range corresponding to the first random-reduction-value algorithm, and randomly selecting a reduction value from the first reduction value range as a reduction value corresponding to the first random-reduction-value algorithm.

7. The method according to claim 1, wherein the determined reduction algorithms comprise at least a first fixed-reduction-value algorithm; and
a reduction value corresponding to the first fixed-reduction-value algorithm is determined by:
obtaining a preset reduction value corresponding to the first fixed-reduction-value algorithm.

8. The method according to claim 1, wherein the determined reduction algorithms comprise at least a first fixed-reduction-target-value algorithm; and
a reduction value corresponding to the first fixed-reduction-target-value algorithm is determined by:
obtaining a preset first reduction target value corresponding to the first fixed-reduction-target-value algorithm, calculating a difference between the order amount in the order information and the first reduction target value, and determining the difference as a reduction value corresponding to the first fixed-reduction-target-value algorithm.

9. The method according to claim 1, wherein after the performing reduction adjustment on an order amount in the order information according to the first reduction value, and performing order processing based on the adjusted order information, the method further comprises:
sending a payment success notification to a terminal on which a payment account in the order information is logged in, wherein the payment success notification carries the first reduction value and the adjusted order amount.

10. The method according to claim 1, wherein the at least one preset transaction feature parameter comprises one or more of:
a merchant identifier, an order amount, a quantity of orders submitted by a payment account, a type of a payment fund account, or region information of a merchant.

11. A server, comprising:
a memory, storing one or more program instructions for a method for processing an order, and
one or more processors, coupled to the memory and, when executing the one or more program instructions, configured to:
receive an order processing request carrying order information, and determine a parameter value of at least one preset transaction feature parameter according to the order information;
determine, according to a pre-stored corresponding relationship between a parameter value condition and a reduction algorithm, at least one parameter value condition in line with the parameter value from parameter value conditions contained in the corresponding relationship, and determine a reduction algorithm corresponding to the at least one parameter value condition;
separately determine, according to each determined reduction algorithm, a reduction value corresponding to each reduction algorithm, and select, from determined reduction values, a first reduction value with a maximum value; and
perform reduction adjustment on an order amount in the order information according to the first reduction value, and perform an order processing based on the adjusted order information.

12. The server according to claim 11, wherein the one or more processors are further configured to:
receiving the order processing request that is sent by a terminal and carries the order information;
obtaining a total quantity of reductions of pre-stored reduction algorithms within a time period from a preset historical moment to a current moment; and
determine, when the total quantity of reductions is less than a preset quantity upper limit, the parameter value of the at least one preset transaction feature parameter according to the order information.

13. The server according to claim 11, wherein the one or more processors are further configured to:
receiving the order processing request that is sent by a terminal and carries the order information;
obtaining a total quantity of reductions of a payment account identifier contained in the order information sent by the terminal within a time period from a preset historical moment to a current moment; and
determine, when the total quantity of reductions is less than a preset quantity upper limit, the parameter value of the at least one preset transaction feature parameter according to the order information.

14. The server according to claim 11, wherein the one or more processors are further configured to:
separately obtaining a sum of reduction values of the reduction algorithm corresponding to the at least one parameter value condition within a time period from a preset historical moment to a current moment; and
determine, from the reduction algorithm corresponding to the at least one parameter value condition, a reduction algorithm having a sum of reduction values less than a preset upper limit of a reduction value.

15. The server according to claim 11, wherein the one or more processors are further configured to:
separately obtaining a quantity of reductions of the reduction algorithm corresponding to the at least one parameter value condition within a time period from a preset historical moment to a current moment; and
determine, from the reduction algorithm corresponding to the at least one parameter value condition, a reduction algorithm having a quantity of reductions less than a preset quantity upper limit.

16. The server according to claim 11, wherein:
the determined reduction algorithms comprise at least a first random-reduction-value algorithm; and
a reduction value corresponding to the first random-reduction-value algorithm is determined by:
obtaining a preset first reduction value range corresponding to the first random-reduction-value algorithm, and randomly selecting a reduction value from the first reduction value range as a reduction value corresponding to the first random-reduction-value algorithm.

17. The server according to claim 11, wherein:
the determined reduction algorithms comprise at least a first fixed-reduction-value algorithm; and
a reduction value corresponding to the first fixed-reduction-value algorithm is determined by:
obtaining a preset reduction value corresponding to the first fixed-reduction-value algorithm.

18. The server according to claim 11, wherein:
the determined reduction algorithms comprise at least a first fixed-reduction-target-value algorithm; and
a reduction value corresponding to the first fixed-reduction-target-value algorithm is determined by:
obtaining a preset first reduction target value corresponding to the first fixed-reduction-target-value algorithm, calculating a difference between the order amount in the order information and the first reduction target value, and determine the difference as a reduction value corresponding to the first fixed-reduction-target-value algorithm.

19. The server according to claim 11, wherein the one or more processors are further configured to:
sending a payment success notification to a terminal on which a payment account in the order information is logged in, wherein the payment success notification carries the first reduction value and the adjusted order amount.

20. A non-transitory computer-readable storage medium containing computer-executable program instructions for, when executed by a processor, performing a method for processing an order, the method comprising:
receiving an order processing request carrying order information, and determining a parameter value of at least one preset transaction feature parameter according to the order information;
determining, according to a pre-stored corresponding relationship between a parameter value condition and a reduction algorithm, at least one parameter value condition in line with the parameter value from parameter value conditions contained in the corresponding relationship, and determining a reduction algorithm corresponding to the at least one parameter value condition;
separately determining, according to each determined reduction algorithm, a reduction value corresponding to each reduction algorithm, and selecting, from determined reduction values, a first reduction value with a maximum value; and
performing reduction adjustment on an order amount in the order information according to the first reduction value, and performing an order processing based on the adjusted order information.
